(19) United States
(12) Patent Application Publication
(10) Pub. No.: US 2026/0004941 A1
(43) Pub. Date: Jan. 1, 2026

(54) SYSTEMS, METHODS, AND APPLICATIONS OF INTERSTITIAL PSEUDO-MUON FUSION

(71) Applicants: Phillip H. Wang, Roswell, GA (US); D. Scott Lucas, Ridgefield, WA (US)

(72) Inventors: Phillip H. Wang, Roswell, GA (US); D. Scott Lucas, Ridgefield, WA (US)

(21) Appl. No.: 18/329,861

(22) Filed: Jun. 6, 2023

Related U.S. Application Data
(60) Provisional application No. 63/327,901, filed on Apr. 6, 2022.

(51) Int. Cl. G21B 3/00

(52) U.S. Cl. CPC G21B 3/004; G21B 3/006

(57) ABSTRACT

A method and apparatus for producing nuclear-fusion reactions through interstitial confining of pseudo-muons. The apparatus comprises a resonance chamber substantially surrounded by a neutron reflector. Installed therein the resonance chamber is a metal sphere, having thereabout the sphere one or more rare-earth barium copper oxide (REBCO) electron H−/D− guns disposed toward the resonance chamber, a target/cooling medium inlet and outlet for conveyance of energy, gas, or material to and from the sphere, and a high-pressure gas supply and vacuum pump substantially enveloping the sphere and chamber. By assembling the apparatus, fusion is accomplished using interstitial pseudo-muon fusion (IPMF) and the production of Molybdenum-99 as well as manufacturing of other materials and/or compounds and waste treatment processing using high-density neutron radiation from IPMF occurs.

### CROSS-REFERENCE TO RELATED APPLICATIONS

To the full extent permitted by law, the present United States Non-Provisional patent Application hereby claims priority to and the full benefit of, United States Provisional application entitled “Interstitial Pseudo-Muon Fusion and the Production of Molybdenum-99 using High Density Neutron Radiation from IPMF,” having assigned Ser. No. 63/327,901, filed on Apr. 6, 2022, which is incorporated herein by reference in its entirety.

### FEDERALLY SPONSORED RESEARCH OR DEVELOPMENT

None

### PARTIES TO A JOINT RESEARCH AGREEMENT

None

### REFERENCE TO A SEQUENCE LISTING

None

### BACKGROUND OF THE DISCLOSURE

### Technical Field of the Disclosure

The instant disclosure generally relates to systems, methods, and applications to produce controlled nuclear fusion reactions. More particularly, the instant disclosure relates improved techniques and systems to enhance the quantum tunneling of nucleons in order to achieve self-sustained fusion reactions at great efficiencies.

The instant disclosure is not limited to any particular energy production technology, electrical power, atomic element, atomic isotope, or industrial application.

### Description of the Related Art

Various proposed means to achieve a controlled nuclear fusion reaction have been documented. Such proposed means may generally include fusion reactors that deploy and energize Deuterium-Tritium fuel to initiate a fusion reaction within a reaction chamber in order to produce electricity. In general, there may exist three categories of existing proposed, theoretical, and/or experimental nuclear fusion reactors: high-temperature plasma magnetic confinement (e.g., Tokamak and Stellarator methods), inertial confinement, and muon catalyst systems.

As may be generally understood by those having ordinary skill in the art, Deuterium and Tritium are isotopes of hydrogen. By definition, all isotopes of hydrogen have one proton. In the most commonly naturally occurring isotope, Protium (¹H), no neutron is present. Deuterium (²H), another naturally occurring hydrogen isotope, additionally contains one neutron. Tritium (³H), yet another naturally occurring isotope of hydrogen, has two neutrons more than Protium. The additional neutron(s) present in Deuterium and Tritium means that each possess heavier ion masses than Protium, the isotope of hydrogen with no neutrons. When Deuterium and Tritium fuse, they can create a helium nucleus, with two protons and two neutrons in addition to a release of energy as products of the fusion. The reaction releases an energetic neutron, the energy of which may possibly be captured. Many of the most commonly proposed solutions to generate a controlled nuclear fusion reaction to establish and be utilized in fusion power plants would convert the energy released from such a fusion reaction into electricity to power homes, businesses, and other electrification needs.

The first category of such proposed fusion systems, magnetic confinement methods, may suffer from significant impediments in realizing a practical furnace. These may include disruption due to instability and suitable furnace wall materials. Another category, inertial containment methods, may suffer other impediments, such as the need to further develop and improve laser light sufficient to raise energy levels to generate a fusion reaction, a lack of energy recovery methods, and the like. The third category, the muon catalyst method, does not require extreme energy/temperature inputs, and the benefits and drawbacks of such proposed systems are discussed infra.

In the first two categories of proposed reactions, systems, and methods and their laboratory experimentations to achieve controlled fusion reactions (magnetic confinement and inertial containment), Deuterium-Tritium fuel may be contained at a target and raised to temperatures several times Earth's sun's core temperature. In magnetic confinement reactions, magnetic fields may confine fusion fuel in the form of a plasma when sufficient temperatures are reached. In inertial confinement reactions, targets may be compressed and heated and then filled with fuel and energy may be deposited in the target's outer layer, which explodes outward causing shockwaves that travel through the target, further compressing and heating the fuel until a sufficiently powerful shockwave generates fusion. Each of the first two categories pose significant challenges to those having ordinary skill in the art seeking to develop economically and energetically productive systems, methods, and uses. For example, Deuterium-Tritium fuel may generally be expensive to produce, acquire, and store. Additionally, raising the fuel's temperature to such high degrees may generally be cost-prohibitive, technically difficult to contain, difficult to capture released energy, and economically/energy inefficient from an input/output perspective. Many proposals seeking to address these concerns to produce controllable nuclear fusion reactions do so by lowering the temperature and/or energy required to initiate the reaction or through other steps to achieve beneficial output once the reaction has initiated. Other drawbacks of these proposed systems may include reactor contamination caused by 14.06 MeV neutrons and requirements for devices of great size to achieve the temperatures required, devices including but not limited to power supplies, capacitors, and lasers. Such devices may include examples such as pinched discharge devices, Stellarators, magnetic mirrors, Astrons, the like and/or combinations thereof. These large devices may be expensive, unwieldy, and otherwise cost-prohibitive in the energy production and/or laboratory setting.

Given that the proposed and experimental temperatures, and therefore energy requirements, necessary for a fusion reaction to occur is vastly greater even than that of Earth's sun, and that fusion reactions are known, understood, observed, and/or theorized to occur across every star in the Universe, there may exist an incongruency in how such reactions have begun and continue across the universe naturally, but cannot be achieved without greater than observed temperatures when performed experimentally. In other words, star core temperatures may be much smaller than proposed and experimental fusion may be understood to be required. In fact, Earth's sun's core is not hot enough to initiate fusion, at least according to classical physics. Therefore, a natural explanation must exist for achieving and sustaining fusion at temperatures at, approximate, or below that of a star that has not been accounted for experimentally. One such explanation may be quantum tunneling. Quantum tunneling is a phenomenon that explains how particles can pass through barriers that they do not ordinarily possess sufficient energy to overcome, at least according to classical physics. According to the theory and phenomenon, the wave function of a particle can spread out over a region of space. Due to this, the particle has a non-zero chance of being found on the other side of any certain energy barrier, even if it does not have sufficient energy in the classical understanding, to cross said barrier. As protons approach the Coulomb barrier (the energy barrier due to electrostatic interaction that two nuclei need to overcome to be close enough for a fusion reaction), they may still likely repel one another until sufficient energy/temperature may induce fusion. However, when a large quantity of protons are raised in energy there is a chance, albeit small, that even when average proton energy levels remain beneath that of the Coulomb barrier, one or more protons within a confined system exists at or above the Columb barrier, and therefore cause fusion with another proton in the system. Since stars contain nearly incomprehensible quantities of protons, this may be a likely explanation as to how stars have formed and how their fusion reactions proceed at such comparably low temperatures. Hence, when the wave function of any particular particle crosses the Coulomb barrier, the strong forces as may be understood by those having ordinary skill in the art can be activated to overcome the electrostatic repulsion force, or at least, the possibility becomes more likely.

The third category of reactions, muon-catalyzed reactions, may be known to be able to stably obtain a fusion reaction, but the energy production efficiency may generally suffer and need to be improved before it can be suitably deployed in the generation of electricity. However, it remains the sole category of reactions that can be performed at reasonable and/or room temperatures. Muons are unstable subatomic particles similar to electrons but 207 times more massive. If a muon replaces one of the electrons in a hydrogen atom (molecule), the nuclei of the hydrogen may be drawn consequently 196 times closer to one another. When nuclei move closer together, fusion probability may be increased, causing fusion events to occur at room temperature. The presence of muons among Deuterium-Tritium may increase the likelihood that any one proton pair's Coulomb barrier is exceeded as described above, thereby causing fusion of the pair, and each individual muon may remain capable of proceeding to further cause another fusion reaction at another proton pair, hence, muon's status as a catalytic reaction. A significant drawback, however, may persist. Since muons themselves are unstable subatomic particles, methods for obtaining them may generally require far more energy than could possibly be produced, even through a fusion reaction. Additional challenges may also exist to obtain sufficient energy from such a reaction to achieve an economically justifiable and energy efficient means of electrical production. Furthermore, muons may decay rapidly due to their unstable nature and may therefore be exceedingly difficult and/or expensive to store, or may cause increased wasted energy upon decay. As may be axiomatic to those having ordinary skill in the art, muon catalysis may require an inexpensive and energy-efficient muon source in order to justify such a proposed productive and controlled nuclear fusion reaction capable of electrically powering. Yet other drawbacks of proposed muon catalyst reaction systems may exist, such as the alpha-sticking problem (where the muon binds to the deuteron-triton fusion result, thereby removing the catalyst from proceeding the reaction).

Various improvements to muon-catalyzed reactions have been proposed in order to reduce the energy requirements necessary to generate, store, and use muons, as well as proposals to reduce their decay and induce their continued catalytic activity. However, fusion reactions which produce sufficient usable electronic energy to power commercially-effectively anything has yet to be achieved. Since the focus of such improvements may generally focus on creating circumstances to output more electrical energy than has been input in order to achieve an ideal fusion which could cheaply and/or freely power the global electricity needs, the ability to electrify a power grid with a fusion reaction generator or power plant may still be distant, despite enormous advances in the last few decades. However, there may exist byproducts of such muon-catalyst reactions. Such byproducts may be thought of as non-ideal, in that their production may be more of an unwanted side-product of the muon-catalyzed reaction that “robs” the reaction of its efficiency. However, if such byproducts could instead be valuable materials and/or elements, such byproducts could be synthesized during the muon catalyzed reaction intentionally in order to manufacture the byproduct. Some energy, possibly even in great amounts, could still be obtained from the reaction, and though inefficient from an electrical/energy input/output formulation, it may result in an economically productive system for the manufacture of the byproduct and powering capability. Furthermore, there may exist many dangerous and/or detrimental chemicals, molecules, elements and/or substances, which subsequent to undergoing exposure and/or inclusion in muon-catalyzed reactions, become useful, safe, and/or inert. If treatment of such substances can output energy when included in a proposed muon-catalyzed fusion reaction, the economic productivity of such reactions may be further enhanced.

Therefore, there exists a long felt but unresolved need to develop an economically and energy efficient energy production, manufacturing, and/or waste treatment system via muon-catalyzed fusion reactions. The instant disclosure is designed to address at least some aspects of the problems discussed above. The systems, methods, and applications of interstitial pseudo-muon fusion described herein may be designed to replace or work alongside other various fusion systems, methods and/or applications. Use of the systems, methods, and applications of interstitial pseudo-muon fusion described herein may help overcome many of the limitations of the systems and methods described above.

### SUMMARY

The present disclosure may solve the aforementioned limitations of the currently available proposed fusion reaction systems by providing systems, methods, and applications of interstitial pseudo-muon fusion. Interstitial Pseudo-Muon Fusion (IPMF) may relate to a method and apparatus for producing controlled nuclear fusion reactions by drastically increasing the probabilistic interactions of atoms via muon catalysis, rather than relying on energy-expensive “hot” fusion. In other aspects, IPMF may include proposed techniques to enhance and/or increase the likelihood of the occurrence of tunnelling of nucleons, thereby opening the possibility of self-sustained fusion reactions while simultaneously lowering the cost, size, and mass of fusors. This may occur by circumventing the temperature requirements of other proposed fusion reactions, reducing the power required needed to initiate and/or sustain them, and eliminating/reducing the confinement requirements of such hot fusion systems and methods. Additionally, the overall economic use of such reaction may be increased by the intentional production of useful byproducts. These may include by way of example and not limitation, the production of medical isotopes, rare earth metals. Additionally, reactants and/or additional materials beyond traditionally proposed hydrogen fuels may be contained within such a reaction in order to produce such useful byproducts, or for instance, the treatment of various dangerous substances. For example, nuclear waste may be included in the fusion reaction to render it inert, restore its ability to be used in fission reactions, or to otherwise treat the nuclear waste in order to make it safe and/or useful. Finally, in addition to the manufacture of useful byproducts and/or treatment of dangerous substances, such reactions may generate electricity and/or be used to provide propulsive forces to a vehicle and/or craft.

Generally, it may be accepted by those having ordinary skill in the art that to produce a self-sustained fusion reaction, the density of the fusionable particles must be maintained at high orders. It may be also accepted that if such density can be contained, other problems and/or drawbacks may be solved. One such problem may be increasing the particle energy levels high enough to overcome the repelling forces therein. It then may stand to reason that many problems inherent in magnetic-field devices may be overcome through the use of electric fields. Additionally, less evident aspects may be developed to further address these problems.

In one aspect, this may include using abundantly available Deuterium-Deuterium (D-D) within fuel mixtures to minimize irradiation damage and contamination of reactor structures by high-energy neutrons. In another aspect, high frequency and large alternating positive and negative charges on an anode and cathode may be introduced to create a pressure spike within a target lattice. This may be accomplished by alternatively crushing and expanding the D-D interaction, encouraging fusion. In yet another aspect, high temperature superconductors (HTS) accelerator guns having cesium coating may produce synthetic muons at significantly reduced energy requirements. Since Muons are 207 times heavier than electrons, they may dramatically increase the probability of quantum tunneling in D-D interactions as discussed supra. Finally, in what may be an overarching principal of these aspects, and which may be critical to their assembly into an economically productive fusion system, a combination of inertial electrostatic confinement (IEC) with lattice confinement fusion may further enhance the probability of quantum tunneling within such target lattices. IEC may offer the additional benefit of achieving high power density in a comparably small, lightweight reactor. In combination, these aspects may each work synergistically in combination in order to decrease the subatomic distance within the reactor/reaction in order to further increase the probability of quantum tunneling.

In other aspects, the systems, methods, and applications of interstitial pseudo-muon fusion may embrace the approach of meeting energy demands to increase the probability of quantum tunneling by centering on the production of synthetic muons. Such muons may be produced through use of such low work function materials inside spiral magnetic fields with electron guns injected with hydrogen gas. The acquisition of additional electrons by the hydrogen gas may then yield a negative electron charge simulating muons. These “synthetic” muons may then be fired at the center of or target of an IEC device as beams in order to enhance the D-D reactions, which may already be occurring with the IEC device. Further aspects may include D-D ion implantation in Erbium via a lattice confinement fusion. This may benefit from the use of, for example, Tungsten, or other various materials as may be known by those having ordinary skill in the art, in order to produce X-Rays, which may in turn impact the surface of the target for further enhancement of reaction rates and/or probabilities. Of additional importance, another aspect of the disclosed systems, methods, and applications of interstitial pseudo-muon fusion may include the production and control of Kappa (K) distributed energy. K distributed energy for the plasma may require a kinetic approach related, for instance, to the dynamics of beam injection heating. Exploiting quantum vacuum effects from existing et, e-pairs at temperatures one order of magnitude higher than usually achieved in tokamaks, or from intersecting et, e-beams with the plasma to produce μ+μ−(muon) pairs for efficient Coulomb shielding, is believed by those having ordinary skill in the art to require a radical revision of the design of current fusion experiments and system designs. In this regard, a use of H− and H+ pairs may be similarly important. Additionally, further advances in fusion rates may be enhanced by adsorption of deuterons on an Erbium/Palladium surface via a large gas pressure as the adsorption sites are filled according to the equation:

$$P = {( \frac{mT}{2 π} )}^{\frac{3}{2}} \frac{T}{( \frac{N}{n} - 1 )} exp ( - \frac{ε}{T} ) .$$

When, with an energy of −ε per deuteron, the number of deuterons n approaches the number of interstitial sites N, a singularity is theorized and may be shown experimentally to occur, resulting in a larger surface pressure for confining the deuterons and enhancing quantum tunneling probability.

Alone or potentially in combination, many of the aspects of the disclosed systems, methods, and applications of interstitial pseudo-muon fusion may offer various additional benefits when implemented. One such benefit may be enablement of the production of high-density neutron flux. Additionally, the heat released in systems, methods, and applications of interstitial pseudo-muon fusion and IPMF may be potentially recovered through various energy capturing means known to those having ordinary skill in the art. These may include, by way of example and not limitation, steam generation or other heat recovery through various mediums. Various methods of the disclosed IPMF may further generate high-density neutron radiation for multiple applications as may be listed herein or otherwise known to those having ordinary skill in the art, including the production of heat which may be released in the process of neutron generation, which may then be converted for other energy applications through similar and other means. Neutron radiation flux produced from IPMF systems and methods may further have applications in the development of medical isotopes as may be specified herein and known to those having ordinary skill in the art. This may include production of Molybdenum-99 (Mo-99) and its decay product Tc-99m. Such medical isotopes are commonly used in tens of thousands of medical procedures and/or diagnostic tests each day in the United States to diagnose heart disease and cancer, as well as for consumption during other important medical and scientific applications. Ordinarily, the fission of Uranium-235 and/or neutron capture of Mo-98 may be the two main processes for production of Mo-99. Such processes may ordinarily involve nuclear reactors with highly enriched uranium (HEU). HEU is known to be a highly restricted and controlled substance throughout the world because if misused or used mischievously, HEU could potentially endanger the health, safety, and even lives of vast populations and could additionally cause environmental catastrophe. IPMF may instead offer an alternative and/or replacement Mo-99 production and/or manufacturing process without requiring HEU. In such designs and/or systems, a dual-purpose system may be developed (a) utilizing the heat released in the process of neutron generation, which may be converted for other energy applications and (b) production of Mo-99. Such synergistic dual processes may justify the economic costs of generating relatively lower amounts of electrical power (when compared to input energy) since the production of Mo-99, for instance, may be highly economically rewarding. Then, further improvements to IPMF by those having ordinary skill in the art may naturally develop through technological progress the ability to eventually achieve net electrical output, thereby potentially alleviating or eliminating the need to produce a valuable byproduct during IPMF. Another such alternative byproduct may be treatment of dangerous substances. One such dangerous substance that may be capable of being treated during IPMF may be high-level nuclear waste. Since high-level nuclear waste may be known to be dangerously radioactive for hundreds of millennia, much nuclear waste generated during the production of nuclear fission energy may require safe long-term storage means. Instead, various proposals may exist to treat such high-level nuclear waste to either (a) become safe and inert or (b) reactivate for further fission reactions. One such high-level waste treatment method may be bombarding the waste with neutron radiation to transmute it, which may be known to drastically shorten the half-life of radioactivity. This shorter-lived low-level waste may then be managed more easily or even undergo further transformation that render other useful isotopes. IPMF-based transmutation may offer an even safer and cost-effective alternative to fission-based systems. Other critical industrial applications may also be available for IPMF. By way of example and not limitation, these may include radiation effects testing and neutron imaging. Yet another application may include production of rare earth metals, such as neodymium (Nd) and dysprosium (Dy) from, for example praseodymium (Pr) and terbium (Tb), respectively, via transmutation and/or activation by neutrons. These metals may be used across various industries, including in the production of batteries, wind turbines, and solar power generation. Aspects of IPMF, such as neutron radiation, may further interact with various metals, such as steel, to produce gamma rays. Such radiation could then be used to create, for example, food having long-term or even infinite shelf life. This aspect may further be useful for production of ⁶⁰Co.

The foregoing illustrative summary, as well as other exemplary objectives and/or advantages of the disclosure, and the manner in which the same are accomplished, are further explained within the following detailed description and its accompanying drawings.

### BRIEF DESCRIPTION OF THE DRAWINGS

The present disclosure will be better understood by reading the Detailed Description with reference to the accompanying drawings, which are not necessarily drawn to scale, and in which like reference numerals denote similar structure and refer to like elements throughout, and in which:

FIG. 1 is a perspective drawing of an exemplary embodiment of a Interstitial Pseudo Muon Fusor (IPMF) device of the disclosure;

FIG. 2 is a disembodied top plan cross sectional view drawing of an exemplary modular component configuration of the device;

FIG. 3 is a top plan cross sectional view of one exemplary modular component of the device of the disclosure in configured combination with additional modular components; and

FIG. 4 is a flowchart of an exemplary method of the disclosure.

It is to be noted that the drawings presented are intended solely for the purpose of illustration and that they are, therefore, neither desired nor intended to limit the disclosure to any or all of the exact details of construction shown, except insofar as they may be deemed essential to the claimed disclosure.

### DETAILED DESCRIPTION

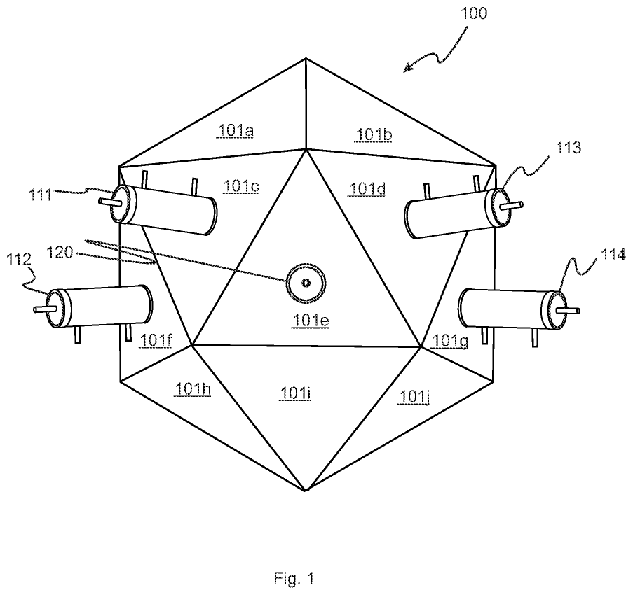

Referring now to FIGS. 1-4, in describing the exemplary embodiments of the present disclosure, specific terminology is employed for the sake of clarity. The present disclosure, however, is not intended to be limited to the specific terminology so selected, and it is to be understood that each specific element includes all technical equivalents that operate in a similar manner to accomplish similar functions. Embodiments of the claims may, however, be embodied in many different forms and should not be construed to be limited to the embodiments set forth herein. The examples set forth herein are non-limiting examples and are merely examples among other possible examples. By way of example, geometrical and/or engineering configuration of the resonance chamber may be adapted for various use cases as may be described herein and otherwise known to those skilled in the art. Furthermore, while the Drawings and corresponding Written Description may explicitly and/or implicitly feature specific numbers of components, adaptations may be made to include more or fewer embodiments of the components herein described. For instance, though one, four, and seven electron guns may be illustrated in the Drawings and described herein, the description is only limited by whole number integers of electron guns. Furthermore, though identically shown and described electron guns may be contained herein, variations may exist and one having ordinary skill in the art may understand to substitute various electron guns or install a variety of suitable electron guns according to the disclosure. Additionally, while many byproduct manufacturing processes and/or waste treatment processes may be described herein, the description is not limited to those specified herein. Many other proposed useful processes may be developed using the IPMF technologies, systems, devices, apparatuses, and methods described herein.

The present disclosure solves the aforementioned limitations of the currently available devices, devices, systems, and methods of muon catalyzed fusion, each of which may solve a particular problem or address a particular aspect to increase the economic productivity of such fusion reactions. By arranging a system according to the principles of IPMF as disclosed herein, many economically productive fusion reactions may be proposed and even achieved.

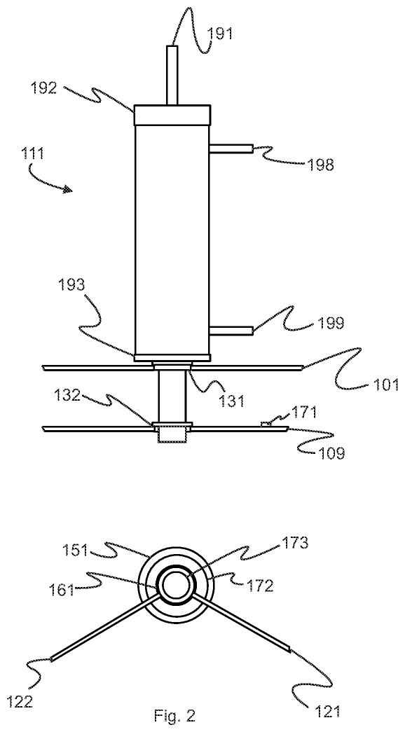

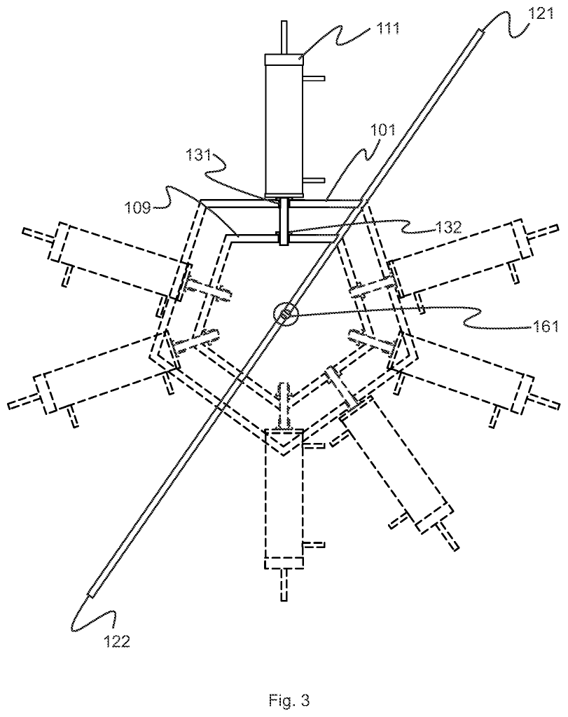

Referring now specifically to FIG. 1, therein illustrated is a perspective drawing of an exemplary embodiment of the system of the disclosure. Generally, the system of the disclosure may feature pseudo muon fusor device 100, which features various aspects. For the sake of clarity, interstitial pseudo muon fusor (IPMF) device 100 may alternatively be referred to herein as IPMF device 100, PMF device 100, or simply device 100. As illustrated therein FIG. 1, PMF device 100 may be constructed to form an icosahedron (20-sided polyhedron). Such construction may be provided, for instance, via twenty individual triangular panels and/or sheets. As illustrated therein FIG. 1, only some of such triangular panels may be visible at any given perspective. As illustrated in the perspective view of FIG. 1, first polyhedron segment 101a, second polyhedron segment 101b, third polyhedron segment 101c, fourth polyhedron segment 101d, fifth polyhedron segment 101e, sixth polyhedron segment 101f, seventh polyhedron segment 101g, eighth polyhedron segment 101h, ninth polyhedron segment 101i, and polyhedron segment 101j may be fully and/or partially visible. For sake of simplicity, given the twenty repetitions of identical and/or near-identical parts, each of first polyhedron segment 101a, second polyhedron segment 101b, third polyhedron segment 101c, fourth polyhedron segment 101d, fifth polyhedron segment 101e, sixth polyhedron segment 101f, seventh polyhedron segment 101g, eighth polyhedron segment 101h, ninth polyhedron segment 101i, and polyhedron segment 101j may be referred to generally as polyhedron segment 101 and represented alone as a component of a modular system as may be illustrated in FIGS. 2-3. Other polyhedrons or geometric constructions as may be known to those having ordinary skill in the art may be capable of producing the features and/or benefits of the disclosure, and the disclosure is not limited to an icosahedron configuration. Connections there among each polyhedron segment 101 may be formed by any means known to those having ordinary skill in the art. Each polyhedron segment 101 may be constructed of a sheet of stainless steel, or of other suitable materials as may be known to those having ordinary skill in the art.

Another modular feature and/or component of PMF device 100 as illustrated in FIG. 1 may include first electron H−/D− gun 111, second electron H−/D− gun 112, third electron H−/D− gun 113, and fourth electron H−/D− gun 114. For sake of simplicity, given the four repetitions of identical and/or near-identical components, each of first electron H−/D− gun 111, second electron H−/D− gun 112, third electron H−/D− gun 113, and fourth electron H−/D− gun 114 may be referred to generally as electron H−/D− gun 111 and represented alone as a component of a modular system as may be illustrated in FIGS. 2-3. While four of electron H−/D− gun 111 are illustrated therein FIG. 1, the description is not so limited and may include any positive integer of electron H−/D− gun 111, depending on the needs and resources available to a person having ordinary skill in the art practicing the system of the disclosure. PMF device 100 may further include multipurpose aperture 120, which may be used for viewing, target insertion/removal, heat removal, vacuum connection, or for energy addition to the target via lasers, microwaves, and ultrasound. Additionally, electron H−/D− gun 111 may protrude through or otherwise access PMF device 100 via such a multipurpose aperture 120, which may not be visible from the perspective view of FIG. 1. Electron H−/D− gun 111 may be a high-performance electron gun utilizing Rare Earth Barium Copper Oxide (REBCO).

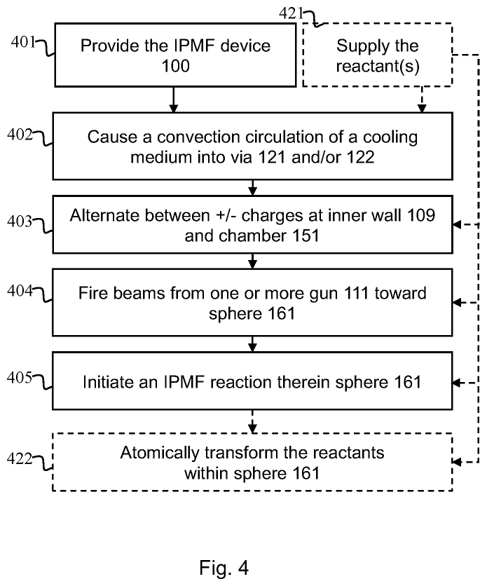

The REBCO electron gun, as may be provided by electron H−/D− gun 111, may be designed to generate and emit a high-intensity electron beam for various applications, including electron microscopy, particle accelerators, and other scientific and industrial processes requiring precise electron manipulation. Such electron H−/D− gun 111 having these configurations and capabilities may be widely known and readily available for purchase by those having ordinary skill in the art, though a brief summary of the parts, aspects, and features thereof is provided herein. Conventionally, such electron H−/D− gun 111 without the REBCO configuration and manufacture may be otherwise constructed using conventional metallic conductors or low-temperature superconductors. However, these materials often have limitations in terms of their critical temperature, current density, and energy efficiency, thereby restricting their application in high-performance electron beam generation. Those having ordinary skill in the art may recognize that the emergence of REBCO superconductors has revolutionized the field of electron gun technology by offering superior properties such as high critical temperatures, high current densities, and efficient energy transfer. These materials allow the electron gun to operate at significantly higher temperatures, resulting in simplified cooling systems and reduced operational costs. Electron H−/D− gun 111 of the disclosure, which may feature REBCO features may incorporate a REBCO superconducting material, which may enable the efficient transport of high currents and high magnetic fields necessary for the generation of a powerful electron beam. Electron H−/D− gun 111 may further consist of a cathode, an anode, and a magnetic lens system, designed to focus and direct the electron beam to a desired target. Essentially, one skilled in the art may desire to use electron H−/D− gun 111 having REBCO superconductors in order to enhance the beam quality, stability, and longevity of the electron gun, enabling high-resolution imaging and precise manipulation of the electron beam, though other configurations and/or technologies offering such benefits may be substituted as may be known to those having ordinary skill in the art. Other features of electron H−/D− gun 111 may further enhance the utility of the proposed PMF device 100. These may include various control and modulation mechanisms integrated into electron H−/D− gun 111 to adjust and customize the beam intensity, focus, and energy. Having described various components, aspects, features, and benefits of PMF device 100, as may be visible and apparent from a person having ordinary skill in the art in receipt of FIG. 1, those components, aspects, features, and benefits internal to PMF device 100 may be further described in relation to FIGS. 2-3 as well as those steps to achieve such benefits from a review of FIG. 4.

Referring now specifically to FIG. 2, therein illustrated is a cross sectional view of an exemplary modular component configuration of PMF device 100. FIG. 2 has been illustrated to exclude redundant modular components that may appear in configuration with one another in a fully assembled embodiment of PMF device 100. Beginning atop the illustration of FIG. 2, a potentially preferred embodiment of electron H−/D− gun 111 having the REBCO features described supra may be illustrated having been installed and/or operably connected through polyhedron segment 101 and inner beryllium reflection anode wall 109 via outer insulated aperture 131 and inner insulated aperture 132, respectively. Electron H−/D− gun 111, in a potentially preferred embodiment, may include gas inlet 191, gun positive voltage 192, gun negative voltage 193, cooling medium inlet 198, and cooling medium outlet 199, as well as other parts, components, and features as may be known and understood by those having ordinary skill in the art. As discussed supra, many variations of electron H−/D− gun 111 may exist in the marketplace and may be additionally custom constructed/assembled/configured for optimal configuration with PMF device 100 as herein described. Inner beryllium reflection anode wall 109 may further feature outer varying polarity voltage source 171. Electron H−/D− gun 111, in the modular arrangement proposed herein, may be focused upon target cathode sphere 161 and/or neutron reflection chamber 151, which may respectively feature inner core varying polarity voltage source 173 and outer core varying polarity voltage source 172. Finally, access path 122 and access path 121 may be configured to provide material insertion/removal for, for example, neutron bombardment of the material therein target cathode sphere 161, or may offer other utility which may be described herein. By way of example and not limitation, access path 121 and access path 122 may function in combination to provide an at least one cooling medium inlet and/or cooling medium outlet, which may be used in connection with e.g., a high-pressure gas supply and/or vacuum pump. Each modular component of the critical aspects that may be featured and illustrated in FIG. 2 may be redundantly included in the potentially preferred icosahedron configuration with electron H−/D− gun 111 installed upon one, many, or all polyhedron segments 101 (see e.g., FIGS. 1 and 3).

Then, with respect to those features, components, and aspects of PMF device 100 as may be illustrated in FIG. 2, certain additional properties may be relevant in a potentially preferred embodiment of PMF device 100. With respect to electron H−/D− gun 111, deuterium gas may be supplied to gas inlet 191 and may be provided with a high positive voltage via gun positive voltage 192 and low negative voltage via gun negative voltage 193, which may be applied across electron H−/D− gun 111, as may be understood by those having ordinary skill in the art. As described above, electron H−/D− gun 111 may be inserted through polyhedron segment 101 and inner beryllium reflection anode wall 109 via corresponding apertures. In a potentially preferred embodiment, each of polyhedron segment 101 and inner beryllium reflection anode wall 109 may be insulated from electron H−/D− gun 111 with, for instance, high-temperature tolerant plastic insulation material or other insulators as may be known by those having ordinary skill in the art in order to prevent a heat transfer between each electron H−/D− gun 111 and each polyhedron segment 101 and inner beryllium reflection anode wall 109. Additionally, polyhedron segment 101 may be grounded to neutral whereas inner beryllium reflection anode wall 109 may be connected to varying polarity voltage source 171. Such configuration, as may be understood by those having skill in the art, may be understood to provide the anode properties of inner beryllium reflection anode wall 109. Gun positive voltage 192, gun negative voltage 193, varying polarity voltage source 171, and other electrical components may be further configured to reverse their polarity in pre-determined frequencies, as may be relevant to the overall operation of PMF device 100.

With respect to other features, components and benefits of PMF device 100 as may be illustrated therein FIG. 2, high voltage sources may be applied to outer core neutron reflection chamber 151 via varying polarity voltage source 172 and target cathode sphere 161 may behave as a cathode via inner core varying polarity voltage source 173. These high voltage sources may further reverse their polarities in sync or in coordination with the frequency of for example, varying polarity voltage source 171. In such exemplary configurations, materials may be inserted into target cathode sphere 161 for neutron bombardment via and/or through one or more of access path 121 and/or access path 122, which may be provided with outside access via one or more of multipurpose aperture 120. Furthermore, materials may be removed from bombardment via one or more of access path 121 and/or access path 122. Heat generated in target cathode sphere 161 may also be removed, extracted, absorbed, captured, the like, and/or combinations thereof via the same (i.e., via access path 121 and/or access path 122), and other utility may exist for access path 121, access path 122, and multipurpose aperture 120, as may be detailed herein. For instance, a vacuum device may be used to create vacuum within PMF device 100 at one or more chambers thereof using the operable combination of multipurpose aperture 120 and either or both of access path 121 and/or access path 122. Additionally, as may be further described herein, microwave radiation, laser/light illumination, and/or ultrasound may be provided. Access path 121 and access path 122 may be simply a trajectory for such activity, beams, radiation, insertion, firing, the like, and/or combinations thereof, or access path 121 and access path 122 may be constructed of a material to form a tube in order to isolate other components of PMF device 100 from the corresponding material, electromagnetic waves, radiation, or other corresponding insertions into multipurpose aperture 120.

Referring now specifically to FIG. 3, therein illustrated is one exemplary modular component of PMF device 100 of the disclosure in configured combination with additional modular components. FIG. 3 has been illustrated to include redundant modular components in configuration with one another, though only one modular component thereof may be annotated in order to retain focus upon the potentially essential configuration of PMF device 100, which may have various features reproduced to achieve the described benefits as may be understood by those having ordinary skill in the art. Beginning atop FIG. 3, a potentially preferred embodiment of electron H−/D− gun 111 having the REBCO features described supra may be illustrated having been installed through polyhedron segment 101 and inner beryllium reflection anode wall 109 via outer insulated aperture 131 and inner insulated aperture 132, respectively. As may be more closely illustrated and described in relation to FIG. 2, electron H−/D− gun 111, in a potentially preferred embodiment, may include gas inlet 191, gun positive voltage 192, gun negative voltage 193, cooling medium inlet 198, and cooling medium outlet 199, as well as other parts, components, and features as may be known and understood by those having ordinary skill in the art. As illustrated in FIG. 3, inner beryllium reflection anode wall 109 may further feature outer varying polarity voltage source 171 (see e.g., FIG. 2). Electron H−/D− gun 111, in the modular arrangement proposed herein, may be focused upon target cathode sphere 161 and/or neutron reflection chamber 151, which may respectively feature inner core varying polarity voltage source 173 (FIG. 2) and outer core varying polarity voltage source 172 (FIG. 2). Finally, access path 122 and access path 121 may be configured to provide material insertion/removal for, for example, neutron bombardment of the material therein target cathode sphere 161. As illustrated therein FIG. 3, each modular component of the critical aspects that may be featured and illustrated in FIG. 2 may be redundantly included in the potentially preferred icosahedron configuration with electron H−/D− gun 111 installed upon one, many, or all polyhedron segments 101. While seven of electron H−/D− gun 111 may be illustrated therein FIG. 3, the number of electron H−/D− gun 111 of the disclosure is only limited to positive integers and configurations may only be limited by the number of sides of the corresponding polyhedron of PMF device 100.

Then, with respect to those features, components, and aspects of PMF device 100 as may be illustrated in FIG. 3, certain additional properties may be relevant in a potentially preferred embodiment of PMF device 100. For instance, inner beryllium reflection anode wall 109 may be constructed of beryllium, or other suitable neutron-reflective materials facing toward the center of PMF device 100, or neutron reflection chamber 151/target cathode sphere 161 as may be understood by those having ordinary skill in the art. Such suitable neutron-reflective materials may be provided via a panel, sheet, coating, the like and/or combinations thereof and may be applied to any suitable construction, such as, for example, a stainless-steel sheet and/or plate. Additionally, with respect to neutron reflection chamber 151, it may further comprise, be constructed of, be treated with, or be coated with a neutron-reflective material/substance. With respect to target cathode sphere 161, those having ordinary skill in the art may understand that such a configuration may yield or be constructed to operate in such a disclosed system of PMF device 100 as a cathode, which may be aligned with and serve as a focal point of each electron H−/D− gun 111. Additional layers of resonance chambers in addition to neutron reflection chamber 151 and target cathode sphere 161 may optionally be provided and such configurations may possess the added benefit of increasing and/or otherwise enhancing the intensity of energy potential of PMF device 100. Each of access path 121 and access path 122 may be used to provide viewing into PMF device 100, target insertion/removal, heat removal/venting/capturing, vacuum connectivity, or for energy addition into neutron reflection chamber 151 and/or target cathode sphere 161 via exemplary technologies, such as lasers, microwaves, ultrasound, the like and/or combinations thereof, and may protrude through one or more of multipurpose aperture 120 through a corresponding polyhedron segment 101.

Having described physical construction, modular combination, and general operation of the features of PMF device 100, which may be featured in potentially preferred embodiments of the disclosure, such teachings may enable one having ordinary skill in the art to practice PMF device 100 and systems thereof. Additionally important aspects of such a system, such PMF device 100, and methods of manufacture, assembly and use thereof are described herein, including the scientific properties and engineering principles thereof and its importance to PMF device 100 in such context(s). Overall, PMF device 100, its systems, and its methods may be understood by those having ordinary skill in the art as the tools and means of producing nuclear-fusion reactions, and more particularly, to a methods and corresponding apparatus(es) for producing high-density neutron flux via controlled nuclear-fusion reactions using interstitial confining of pseudo-muons. The neutron flux may be confined within a neutron reflector coated resonance sphere, such as target cathode sphere 161, in order to achieve neutron density amplification. In other well-known theorized, experimented, and/or practiced fusion reactions, nuclei of two light elements may generally be combined to form a nucleus of a single heavier element, together with a release of the excess binding energy in the form of sub-atomic particles (e.g., energized neutrons and protons). As described in the Background and Summary supra, before positively charged nuclei can be brought close enough together for fusion to take place, sufficient energy must be supplied to overcome the forces of electrostatic repulsion between them. There are many possible reactions involving the combination of two light nuclei which may be accompanied by the release of energy, but hydrogen isotopes (deuterium and tritium) as well as helium, under the proper circumstances, may be considered to be the most likely to produce fusion reactions which may be considered to be controllable rather than uncontrolled. To produce a self-sustained fusion reaction which features a release of more energy from the reaction than is required to produce it, the density of the fusionable particles may generally be understood to require maintenance at a high order. It may be generally accepted that if such a density could be so contained, other obstacles to producing a self-sustained fusion reaction could be solved. Principally, that may involve raising the particle energy-levels high enough to overcome their repelling forces, as described supra. Since other distinct proposals for plasma containment offered by predecessors having ordinary skill in the art employ very high magnetic fields (via e.g., pinched discharge, Stellerator, the magnetic mirror, the Astron), which require energy to continuously operate, lower-energy solutions may be substituted according to the disclosure. Additionally, PMF device 100 may be understood by those having ordinary skill in the art of not simply offering substitutions or alternatives, but in fact may be understood to depart widely from such approaches by utilizing sub-monolayer interstitial structure for containing the ionized gases. Through the use of such electric fields provided by various aspects of PMF device 100 and the methods of use described infra, many, if not most, of the complex problems inherent in the magnetic-field devices may be overcome. Such advances include each polyhedron segment 101 of PMF device 100 being insulated from each polyhedron segment 101 and additionally grounded for safety. Additionally, inner beryllium reflection anode wall 109 may act as the anode and PMF device 100 may feature concentric cathode inside its volume. Inner beryllium reflection anode wall 109 may feature pre-determined openings, such as inner insulated aperture 132 for the injection flow of electrons and positively/negatively charged ions by one or more electron H−/D− gun 111. target cathode sphere 161 may amplify neutron(s) generated from the target, while the inner core varying polarity voltage source 173 and/or outer core varying polarity voltage source 172 (which may be constructed of or to form a palladium/erbium electrode in the center) may absorb/emit electrons and/or deuterons/tritons in the central volume, with an alternating positive/negative charge provided by the components described supra. Positive and negatively charged deuterium/tritium ion gases, liquids or nano-solids may be injected via one or more electron H−/D− gun 111 at and/or toward a location of the central volume of PMF device 100, and may occur at a negative potential lower than the anode, which may then be beamed to the central portion with the one or more electron H−/D− gun 111 held to superconducting magnetic and electric field conditions for focusing. Further features may include an alternating positive/negative space is used on the cathode. The polarity of outer core varying polarity voltage source 172 and/or inner core varying polarity voltage source 173 may alternate in coordination at pre-determined frequency, which may in turn result in a high-density layer at the cathode so that ions at the central point of PMF device 100 may result in nuclear fusion according to the following reactions, as may be understood by those having ordinary skill in the art:

$${}_{1}^{} {H}_{}^{2} + {}_{1}^{} {H}_{}^{2} = {}_{1}^{} {p}_{}^{1} + {}_{1}^{} {H}_{}^{3} ( + 4. MeV )$$

$${}_{1}^{} {H}_{}^{2} + {}_{1}^{} {H}_{}^{2} = {}_{0}^{} {n}_{}^{1} + {}_{2}^{} {He}_{}^{3} ( + 3.3 MeV )$$

$${}_{1}^{} {H}_{}^{2} + {}_{2}^{} {He}_{}^{3} = {}_{1}^{} {p}_{}^{1} + {}_{2}^{} {He}_{}^{4} ( + 18.3 MeV )$$

$${}_{1}^{} {Li}_{}^{6} + {}_{0}^{} {n}_{}^{1} = {}_{2}^{} {He}_{}^{4} + {}_{1}^{} {H}_{}^{3} ( + 4.8 MeV )$$

Electrons and/or negatively charged deuterons in connection with tritons and/or hydrogen ions may be introduced into PMF device 100 via one or a plurality of electron H−/D− gun 111 and may travel within the space of one or more of the electrodes of PMF device 100, including target cathode sphere 161 therein, which may thereby continue to travel via circuitous routes therein. Inner beryllium reflection anode wall 109, or variations thereof as may be herein described, may be magnetically shielded around openings thereon such that electron interactions thereof, such as e.g., Bremsstrahlung or braking radiation, may occur and such that high energy electron losses may become negligible. Then, in configurations where PMF device 100 includes a plurality of electron H−/D− gun 111, they may be arranged such that they may be understood to be spherically spaced and diametrically aligned, forming beam axes which may then intersect at the center of target cathode sphere 161. As illustrated in FIGS. 1-3, appropriate openings through each polyhedron segment 101 may be formed from each of multipurpose aperture 120 and outer insulated aperture 131 and through each inner beryllium reflection anode wall 109 from each inner insulated aperture 132. Additionally, additional apertures, openings, holes, mesh, or ion-transparent materials may be provided in each of neutron reflection chamber 151 and target cathode sphere 161 for passage of the ions. Yet other apertures or the like may allow the movement of positively charged particles outwardly from the interior target cathode sphere 161. Such particles may be biased negatively to prevent the flow of electrons into the interelectrode space therebetween outer core varying polarity voltage source 172 and inner core varying polarity voltage source 173. Alternating voltage may applied between the inner beryllium reflection anode wall 109 and target cathode sphere 161. Ions from one or more electron H−/D− gun 111 may be propelled and focused into the center of the target cathode sphere 161, thereby establishing in the interior of target cathode sphere 161 a series of concentric spherical sheaths of alternating maxima and minima potentials, which may be understood by those having ordinary skill in the art as “virtual electrodes.” The ions in the innermost virtual electrode may experience fusion energy levels, whereby fusion may occur. They may then be contained at a density sufficient to produce a self-sustained fusion reaction via the mechanisms and components as herein described. The core of target cathode sphere 161 may have natural and/or forced convection circulation of cooling medium to remove heat via one or more of multipurpose aperture 120, access path 121, and/or access path 122 as illustrated and described in relation to FIGS. 1-3. The paths, tubes, and/or pipes of access path 121 and/or access path 122 may also be used to move materials for production of medical isotopes such as Moly-98 into Moly-99 and Technetium 99, which may then be stored and/or consumed for medical imaging and/or other uses as may be known to those having ordinary skill in the art. Alternating positive and negative charges on inner beryllium reflection anode wall 109 and target cathode sphere 161, along with beams formed from electron H−/D− gun 111 may further build up the density of deuterium, tritium, and other isotopes according to the relation:

$${p}_{sub - layer} = {( \frac{mkT}{2 π {2}^{}} )}^{\frac{3}{2}} ( \frac{n}{N} ) [ \frac{kT}{1 - \frac{n}{N}} ] {e}^{- {ε}_{0} / kT} as ( \frac{n}{N} ) \to 1 , {p}_{sub - layer} \to ∞$$

Additionally, a vapor of dilute gas of atoms in equilibrium with a sub-monolayer (one atomic layer) may be “adsorbed” as a film on a plane surface at a temperature T with and energy of −ε per atom, when the number of atoms (n), on the possible number of interstitial sites N, as n→N, in the relation above. As the number of deuterons, n, approaches the number of sites available, the gas pressure may become large, such that fusion can occur between the deuteron's neutron, the solid, or other deuterons to form a charged surface with negatively charged electrons. Such large pressures may additionally decrease the subatomic distance to where deuteron tunneling becomes more probable to occur.

Referring now specifically to FIG. 4, therein illustrated is a flowchart of an exemplary method 400 of the disclosure. Starting at step 401, PMF device 100 of the disclosure may be assembled, constructed, and/or otherwise provided. At step 402, a convection circulation may be caused to occur naturally or artificially via at least one of access path 121 and/or access path 122 as described supra. Then, at step 403, charges at inner beryllium reflection anode wall 109 and neutron reflection chamber 151 may be alternated and at step 404 electron H−/D− gun 111 or a plurality thereof may cause beams to be fired at target cathode sphere 161 according to the disclosure. Then, in circumstances which may be further known by those having ordinary skill in the art, at step 405 an IPMF reaction may occur therewithin target cathode sphere 161. As may be known to those having skill in the art, various steps in such method 400 may occur simultaneously or in other orders. Additionally, step 421 and step 422 may occur, which may involve the introduction of reactants at various other steps 401-405 of method 400 as may be specified herein in order to atomically transform such reactants as described in detail supra.

With respect to the above description then, it is to be realized that the optimum dimensional relationships, to include variations in size, materials, shape, form, position, function and manner of operation, assembly, and use, are intended to be encompassed by the present disclosure.

It is contemplated herein that the device, apparatus and/or assembly of the disclosure and the component parts therein may include a variety of overall sizes, corresponding sizes for, various parts of, and instances thereof including but not limited to: polyhedron segment 101, electron H−/D− gun 111, inner beryllium reflection anode wall 109, multipurpose aperture 120, outer insulated aperture 131, inner insulated aperture 132, neutron reflection chamber 151, target cathode sphere 161, access path 121, access path 122, the like and/or combinations thereof. The description mentions various uses and benefits of the proposed fusion assembly, production of medical isotopes, treatment of nuclear waste, and methods of use, but the invention is not so limited and may have uses, benefits, and applications for uses other than the production of electricity, manufacturing, and waste treatment, including uses such as the identification and treatment of disease, provision of heat to control indoor climate, reclamation/recycling/reuse of various reactants and/or byproducts for other purposes known to those skilled in the art, the like and/or combinations thereof. The mathematical and/or chemical formulas, metals, atomic and molecular compositions (the “formulas”) provided herein are exemplary only. One skilled in the art may understand that variations of the disclosed formulas may offer tradeoffs to the disclosed invention and may be substituted to accomplish similar advantages to the invention of the disclosure. Furthermore, it is contemplated that due to variations in materials and manufacturing techniques, including but not limited to polymers, alloys, metals, assembly, welding, atmospheric composition, the like and combinations thereof, that a variety of considerations may be considered in regard to manufacture of the assembly of the disclosure. Yet still, though the inventor has contemplated one method of manufacturing and assembling a fusion-capable power source to accomplish the result(s) of a greater per-mass electric production capacity than existing technologies allow while additionally providing manufacturing, synthesis of valuable materials, and/or waste treatment, other improvements to this system are possible and intended to be encompassed by the disclosure herein.

The foregoing description and drawings comprise illustrative embodiments of the present disclosure. Having thus described exemplary embodiments, it should be noted by those ordinarily skilled in the art that the within disclosures are exemplary only, and that various other alternatives, adaptations, and modifications may be made within the scope of the present disclosure. Merely listing or numbering the steps of a method in a certain order does not constitute any limitation on the order of the steps of that method. Many modifications and other embodiments of the disclosure will come to mind to one ordinarily skilled in the art to which this disclosure pertains having the benefit of the teachings presented in the foregoing descriptions and the associated drawings. Although specific terms may be employed herein, they are used in a generic and descriptive sense only and not for purposes of limitation. Moreover, the present disclosure has been described in detail, it should be understood that various changes, substitutions and alterations can be made thereto without departing from the spirit and scope of the disclosure as defined by the appended claims. Accordingly, the present disclosure is not limited to the specific embodiments illustrated herein, but is limited only by the following claims.

1. An apparatus for a production of a fusion reaction comprising:
a resonance chamber having a center; and
a neutron reflector substantially surrounding said resonance chamber and having installed therein a metal sphere at said center, having thereabout said metal sphere and said center at least:
a plurality of rare-earth barium copper oxide (REBCO) electron H−/D− guns disposed toward said resonance chamber;
an at least one cooling medium outlet away from said metal sphere;
an at least one cooling medium inlet for conveyance toward said metal sphere; and
a high-pressure gas supply and a vacuum pump substantially enveloping at least said metal sphere and said resonance chamber;
wherein fusion is accomplished using an interstitial pseudo-muon fusion (IPMF) reaction therein said metal sphere.

2. The apparatus of claim 1, wherein a production of Molybdenum-99 from a Molybdenum-98 source material occurs as a result of a high-density neutron radiation from said IPMF reaction.

3. The apparatus of claim 2, wherein said metal sphere comprises an at least one metal from a group of metals, the group of metals consisting of a palladium metal, an erbium metal, compounds thereof, and alloys thereof.

4. The apparatus of claim 3, wherein each of said plurality of REBCO electron H−/D− guns are configured to form a plurality of beams during a firing, each of said plurality of beams intersects said center.

5. The apparatus of claim 3, further comprising a polyhedron shield having a center mass, said center mass corresponding to said center.

6. The apparatus of claim 5, wherein said polyhedron shield forms an icosahedron.

7. The apparatus of claim 6, wherein said icosahedron is formed of a plurality of triangular metal sheets.

8. The apparatus of claim 7, wherein said plurality of triangular metal sheets are a stainless-steel material.

9. The apparatus of claim 8, further comprising a neutron-reflective polyhedron shield sharing said center mass and disposed therebetween said polyhedron shield and said center.

10. The apparatus of claim 9, further comprising a plurality of apertures through said polyhedron shield and said neutron-reflective polyhedron shield, wherein each of said plurality of REBCO electron H−/D− guns are further configured to protrude through some of said plurality of apertures and wherein said cooling medium inlet and said cooling medium outlet are configured through other of said plurality of apertures.

11. The apparatus of claim 10, wherein said plurality of apertures are insulated and form a plurality of seals.

12. The apparatus of claim 1, wherein a nuclear waste is treated via said IPMF reaction therein said metal sphere.

13. A method for a production of a fusion reaction comprising:
providing an apparatus comprising:
a resonance chamber having a center;
a neutron reflector substantially surrounding said resonance chamber and having installed therein a metal sphere at said center, having thereabout said metal sphere and said center at least:
a plurality of rare-earth barium copper oxide (REBCO) electron H−/D− guns disposed toward said resonance chamber;
an at least one cooling medium outlet away from said metal sphere;
an at least one cooling medium inlet for conveyance toward said metal sphere;
a high-pressure gas supply and a vacuum pump substantially enveloping at least said metal sphere and said resonance chamber;
a polyhedron shield having a center mass, said center mass corresponding to said center;
a neutron-reflective polyhedron shield sharing said center mass and disposed therebetween said polyhedron shield and said center; and
a plurality of apertures through said polyhedron shield and said neutron-reflective polyhedron shield, wherein each of said plurality of REBCO electron H−/D− guns are configured to protrude through some of said plurality of apertures and wherein said cooling medium inlet and said cooling medium outlet are configured through other of said plurality of apertures;
causing a convection circulation of a cooling medium into said cooling medium inlet and out of said cooling medium outlet;
alternating a charge between a positive charge and a negative charge at each of said neutron-reflective polyhedron and said resonance chamber;
firing a plurality of beams from said REBCO electron H−/D− guns toward said center; and
initiating a fusion reaction via an interstitial pseudo-muon fusion (IPMF) reaction therein said metal sphere.

14. The method of claim 13, wherein said fusion reaction causes an at least one neutron to fuse to a nucleus of an atom.

15. The method of claim 14, wherein said atom is Molybdenum-98 prior to said fusion reaction and Molybdenum-99 subsequent said fusion reaction.

16. The method of claim 14, wherein said metal sphere comprises an at least one metal from a group of metals, the group consisting of a palladium metal, an erbium metal, compounds thereof, and alloys thereof.

17. The method of claim 16, wherein said polyhedron shield forms an icosahedron.

18. The method of claim 17, wherein said icosahedron is formed of a plurality of triangular metal sheets.

19. The method of claim 14, wherein said plurality of apertures are insulated and form a plurality of seals.

20. The method of claim 14, wherein a nuclear waste is treated via said IPMF reaction therein said metal sphere.
